(19) United States
(12) Patent Application Publication
(10) Pub. No.: US 2016/0116165 A1
(43) Pub. Date: Apr. 28, 2016

(54) IGNITOR

(71) Applicant: Robert Carl Rajewski, Forestburg (CA)

(72) Inventor: Robert Carl Rajewski, Forestburg (CA)

(21) Appl. No.: 14/524,947

(22) Filed: Oct. 27, 2014

(51) Int. Cl. F23Q 3/00; F23G 7/08; H05B 3/03

(52) U.S. Cl. CPC F23Q 3/006; H05B 3/03; F23G 7/08; F23G 2200/00

(57) ABSTRACT

An ignitor has a main body forming a support for insulators, a center electrode, an outer electrode and a spark controller electrically connected to the center electrode, a sleeve extending upward from the main body that incorporates the outer electrode, the center electrode extending through the sleeve to a position adjacent the outer electrode to provide a spark gap between the center electrode and outer electrode, and a barrier between the sleeve and main body to prevent condensation from entering the main body and contacting the insulators.

### TECHNICAL FIELD

Ignitors, particularly for flare stacks.

### BACKGROUND

In the oil and gas industry, there are conditions that require the venting and burning of waste gases from the production process. This venting is done through devices called flare stacks. These flare stacks are elevated pipes standing vertically in the air to vent the waste gas at an elevation that is safe for toxic gas dispersion or high enough that the flare does not ignite ground level flammable items. The operating conditions in which flare stacks have to operate is very harsh and challenging. Temperatures may range from extreme cold to extreme heat in a very short time. Flaring at the flare tip may cause materials to distort or corrode due to the continuous presence of hydrogen sulphide, windy, wet and/or oily conditions. Flare stacks have to be ignited in such a way that the waste gas is burnt safely and dependably.

### SUMMARY

In an embodiment, there is disclosed an ignitor, comprising a main body supporting a center electrode having an upper part and insulators spacing the main body from the center electrode, a spark controller electrically connected to the center electrode, a sleeve having an upper end and a lower end, the sleeve being supported by the main body, the center electrode extending upwards from the main body through the sleeve and the sleeve having a part forming an outer electrode separated from the center electrode by a gap suitable for a spark to travel across the gap in response to energization of the center electrode, and the sleeve providing a flow path for air to reach the gap and being separated from the main body.

In another embodiment, there is a sparking portion of an ignitor, comprising a sleeve having a portion defining a slot, an edge of the slot forming an outer electrode, the slot having an oblong shape having a longer and a shorter dimension, the longer dimension of the slot being oriented circumferentially relative to the sleeve and a center electrode having a protruding portion protruding through the slot in the sleeve to provide an arc gap with the outer electrode, and the center electrode being spaced from the sleeve to provide a flow path for air to travel through the sleeve to the arc gap.

In various embodiments, there may be included any one or more of the following features: the sleeve and the main body may be spaced apart by at least a spacer bar; there may be a barrier between the sleeve and the main body; the barrier may be a cap secured above the main body; the cap may be spaced from the main body by a cylinder; the cylinder may provide a seal to prevent water entering the main body; the slot may be an oblong slot having a longer and a shorter dimension, wherein the longer dimension of the slot may be oriented circumferentially relative to the sleeve the protruding portion of the center electrode may be permitted to move within the slot along the axis of the longer dimension of the slot; the protruding portion of the center electrode may be arranged to move radially with respect to the sleeve; and the barrier may comprise a sealing ring which seals the sleeve to the main body; and the upper end of the sleeve may be capped.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a cross-section view of an ignitor.

FIG. 2 is a detail view of the sparking portion of an ignitor.

FIG. 3 is a cross-section view of the sparking portion of an ignitor.

### DETAILED DESCRIPTION

Immaterial modifications may be made to the embodiments described here without departing from what is covered by the claims.

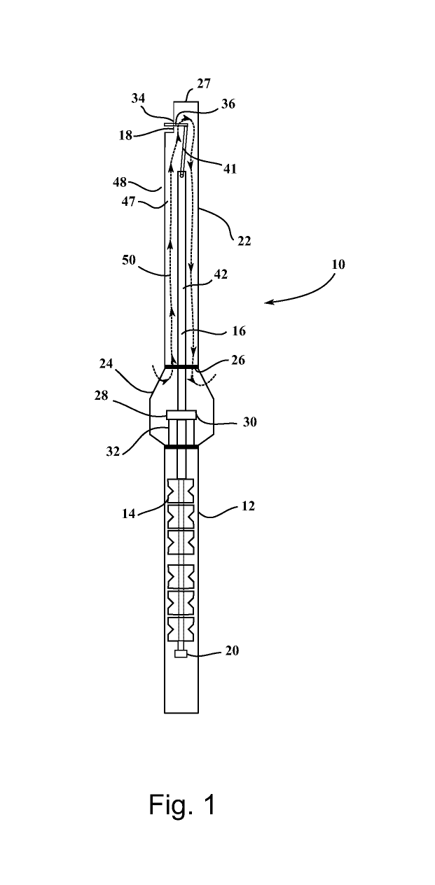

Referring to FIG. 1, there is disclosed an ignitor 10. In an embodiment, the ignitor 10 is 9′ long, and may move up and down on a tracking system from the base of a flare stack to the tip of the flare (not shown). A main body 12 forms a support for insulators 14, a center electrode 16, an outer electrode 18, and a spark controller 20 electrically connected to the center electrode 16. A sleeve 22 surrounds the center electrode 16 and the center electrode 16 extends upwards from the main body 12. The sleeve 22 is separated from the main body 12. In an embodiment, the sleeve 22 is separated from the main body 12 by spacer bars 24. The main body 12 and the sleeve 22 are held apart and the sleeve 22 is open at the lower end 26 to provide a flow path for air movement in the sleeve 22 to be used for ignition and to allow any moisture in the sleeve 22 to be blown out or run out of the sleeve 22 in liquid state. This prevents ice from building up in the sleeve 22 and grounding the center electrode 16. The sleeve 22 has a part, in this case an edge forming a hole 34 in the sleeve 22, that forms an outer electrode separated from the center electrode 16 by a gap suitable for a spark to travel across the gap in response to energization of the center electrode 16.

The sleeve 22 is preferably 3″ in diameter and made of any appropriate material that is strong and durable under high heat and corrosive conditions, but may be stainless steel. In an embodiment, the sleeve 22 is cylindrical, and is short and open at the lower end 26 to allow hot or cold condensations that form within the sleeve 22 to run freely out of the lower end 26. The upper end 27 of the sleeve 22 may be capped.

The main body 12 houses the center electrode insulators 14. The main body 12 is the primary support for the ignitor 10 and may be moved up and down the flare. At the top of the main body 12 is a barrier 28. The barrier 28 may be a cap 30 which is spaced from the main body 12 by a watershed sleeve 32. The barrier 28 inhibits moisture and heat from reaching the main body 12, for example to prevent rain and snow from coming into contact with the insulators 14. Insulators 14 may be located in the interior of the main body 12, adjacent the center electrode 16. The barrier 28 may seal the top of the main body 12. In an embodiment, the barrier 28 is a drip roof that extends over the watershed sleeve 32. The center electrode 16 preferably extends through the sleeve to a position near the top of the sleeve 22 so that the insulators 14 are separated from the burning zone below the burning zone of the flare tip, allowing the insulators 14 to remain in a dry, cool area. Keeping the insulators 14 dry and cool extends the lifetime of the insulators 14. The center electrode 16 may be rotated around as needed without doing arc on the sleeve 22.

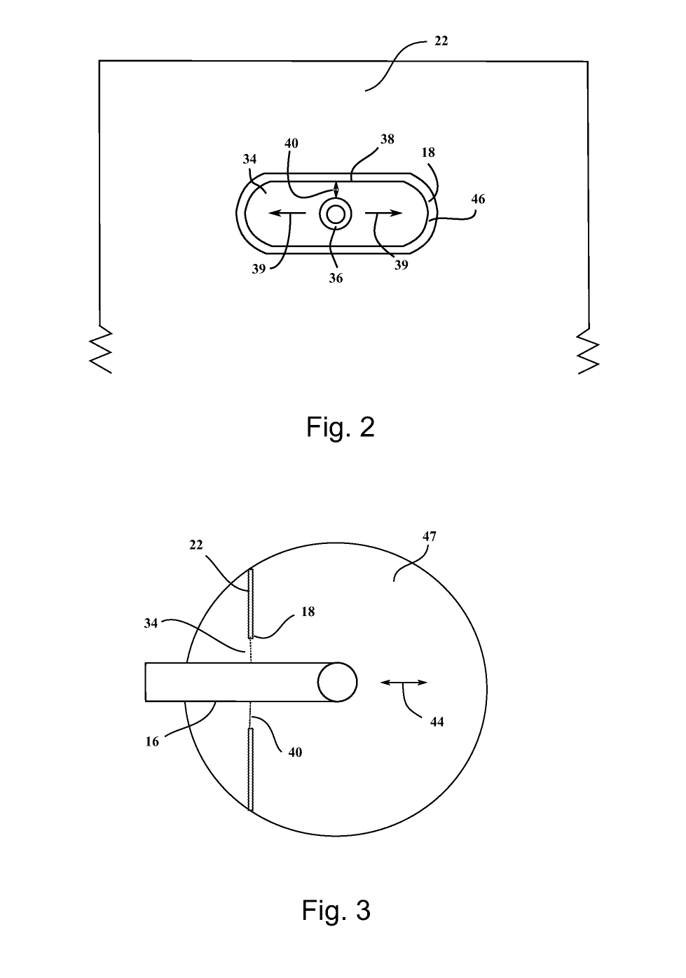

Referring to FIGS. 1-3, there is disclosed a hole 34 in the sleeve 22. In an embodiment, a protruding portion 36 of the center electrode 16 protrudes through the hole 34. As shown in FIG. 2, the hole 34 may be a slot, and the slot may be oblong, having a longer dimension and shorter dimension. In an embodiment, the longer dimension 38 of the hole 34 is oriented circumferentially to the sleeve 22. In an embodiment, the hole 34 is ⅜″ wide ×1″ long. The oblong shape of the hole 34 allows the protruding portion 36 of the center electrode 16 to move from side to side along the axis 39 of the longer dimension 38 of the hole 34. In an embodiment, the protruding portion 36 of the center electrode 16 may move up to ¾″ without touching the outer electrode 18 and the protruding portion 36 of the center electrode 16 is ⅛″ diameter, allowing a constant arc gap 40 between the protruding portion 36 of the center electrode 16 and outer electrode 18. The lower end or some portion of the upper part 41 of the center electrode 16 is fixed to the main part 42 of the center electrode 16 so that the top of the upper part of the center electrode 16 can oscillate in a horizontal plane. The protruding portion 36 of the center electrode 16 is attached to the upper part 41 of the center electrode 16. As shown in FIG. 3, the protruding portion 36 of the center electrode 16 may also move radially 44 in and out of the sleeve 22 without touching the sleeve 22. In an embodiment, the protruding portion 36 of the center electrode 16 may move up to ¾″ radially 44 without touching the sleeve 22. Permitting movement of the protruding portion 36 of the center electrode 16 both radially 44 and circumferentially allows the protruding portion 36 of the center electrode 16 to move in four directions without changing the size of the arc gap 40. In an embodiment, the protruding portion 36 of the center electrode 16 may move up to ¾″ in each of the four directions without changing the arc gap 40, as shown in FIGS. 2 and 3. In an embodiment, the ignitor 10 arcs for a 3 second period every 40 seconds.

The center electrode 16 may be a tungsten electrode. Standard stainless steel does not like to release the electric ions in the electric arc, and regular stainless steel holds the discharging arc current and reduces the arc strength tremendously. A stainless steel electrode would hold the arc discharge, and put a back load on the discharge coil and trigger circuit and burn the coil and circuit out quickly. Tungsten is pure and releases the ions easily and completely and relieves all the back feed and weak spark problems. Depending on the embodiment, different materials may be used for the electrodes.

The outer electrode 18 may be made of tungsten or stainless steel. As shown in FIG. 2, the outer electrode 18 may form an edge 46 of the hole 34. The outer electrode 18 may form part of the edge 46 of the hole 34 which is proximate to the interior 47 of the sleeve 22. In an embodiment, the outer electrode 18 is the sleeve 22.

As shown in FIGS. 1-3, the arc gap 40 is formed where the center electrode 16 protrudes through the hole 34. Ignition occurs when fresh air joins combustible gas to the exterior 48 of the sleeve 22 at hole 34 and the arc lights the air and fuel mixture. The outside of the sleeve 22 may be used as the grounding circuit for the high energy arc to travel through. In an embodiment, the sleeve 22 is made of stainless steel so that it does not warp much in high heat and crosswind conditions, thus allowing the center electrode 16 to remain aligned and ready to ignite gases.

As shown in FIG. 1, in an embodiment, the sleeve 22 has an opening in addition to the hole 34 to permit air flow 50 to the arc gap 40 from the interior 47 of the sleeve 22, to allow the air to mix with gas at the arc gap 40 to facilitate ignition of the gas. The air flow 50 preferably originates at an opening of the lower end 26 of the sleeve 22, and flows to the interior 47 of the sleeve 22, though the sleeve 22 to the hole 34 in the sleeve. Some of the air flow 50 may flow back through interior 47 of the sleeve 22 and out of the sleeve 22 through the lower end 26. In an embodiment, the hole 34 is small enough that it does not allow gas to enter the interior 47 of the sleeve 22 and burn in the interior 47, which protects the center electrode 16 from being exposed to high heat and hydrogen sulphide oxidation. The center electrode 16 is surrounded by the sleeve 22 and is spaced from the sleeve 22 so that the center electrode 16 does not arc from the center electrode 16 to the sleeve 22 except at the arc gap 40.

The lower end 26 of the sleeve 22 may be sealed by a sealing ring (not shown). The sleeve 22 and the main body 12 may be separated by the sealing ring. The sealing ring may also seal the sleeve 22 to the main body 12. The sealing ring may act as a barrier to protect the insulators 14 from high heat and corrosion from flame flames extending down the sleeve 22. A protective flare tip (not shown) may be used in conjunction with ignitor 10 to provide air flow to the arc gap 40. The flare tip may be any flare tip, but preferably is a Prism V-Cool flare tip from Prism Integrated Solutions Inc., of Stettler Alberta.

Immaterial modifications may be made to the embodiments described here without departing from what is covered by the claims. In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1. An ignitor, comprising:
a main body supporting a center electrode and insulators spacing the main body from the center electrode;
a spark controller electrically connected to the center electrode;
a sleeve having an upper end and a lower end, the sleeve being supported by the main body;
the center electrode extending upwards from the main body through the sleeve and the sleeve having a part forming an outer electrode separated from the center electrode by a gap suitable for a spark to travel across the gap in response to energization of the center electrode, the sleeve providing a flow path for air to reach the gap; and
the sleeve being separated from the main body.

2. The ignitor of claim 1 in which the part forming an outer electrode comprises an edge defining a hole in the sleeve, and the center electrode has a protruding portion that protrudes through the hole.

3. The ignitor of claim 1 in which the sleeve and the main body are spaced apart by at least a spacer bar.

4. The ignitor of claim 1 further comprising a barrier between the sleeve and the main body.

5. The ignitor of claim 4 in which the barrier comprises a cap secured above the main body.

6. The ignitor of claim 5 in which the cap is spaced from the main body by a cylinder.

7. The ignitor of claim 6 in which the cylinder provides a seal to prevent water entering the main body.

8. The ignitor of claim 2 in which the hole has a longer and a shorter dimension, the longer dimension of the hole being oriented circumferentially relative to the sleeve.

9. The ignitor of claim 8 in which the protruding portion of the center electrode is arranged to move within the hole along the axis of the longer dimension of the slot.

10. The ignitor of claim 1 in which the protruding portion of the center electrode is arranged to move radially with respect to the sleeve.

11. The ignitor of claim 4 in which the barrier comprises a sealing ring which seals the sleeve to the main body.

12. The ignitor of claim 1 in which the upper end of the sleeve is capped.

13. A sparking portion of an ignitor, comprising:
a sleeve having a portion defining a slot;
an edge of the slot forming an outer electrode, the slot having an oblong shape having a longer and a shorter dimension, the longer dimension of the slot being oriented circumferentially relative to the sleeve; and
a center electrode extending through the sleeve and having a protruding portion protruding through the slot in the sleeve to provide an arc gap with the outer electrode, the center electrode being spaced from the sleeve to provide a flow path for air to travel through the sleeve to the arc gap.

14. The sparking portion of the ignitor of claim 13 in which the protruding portion of the center electrode is arranged to move within the slot along the axis of the longer dimension of the slot.

15. The sparking portion of the ignitor of claim 13 in which the protruding portion of the center electrode is arranged to move radially with respect to the sleeve.
